(19) United States
(12) Patent Application Publication
(10) Pub. No.: US 2004/0240671 A1
(43) Pub. Date: Dec. 2, 2004

(54) Method for remote loading of an encryption key in a telecommunication network station

(76) Inventors: Hai-Tao Hu, Beijing (CN); Li-Jun Fan, Beijing (CN); Zai-Xing Zhao, Beijing (CN)

Correspondence Address: BURNS DOANE SWECKER & MATHIS L L P, POST OFFICE BOX 1404, ALEXANDRIA, VA, 22313-1404, US

(21) Appl. No.: 10/480,837

(22) PCT Filed: Jun. 17, 2002
(86) PCT No.: PCT/FR02/02088

(30) Foreign Application Priority Data
Jun. 15, 2001 (FR) 01/07865

(51) Int. Cl. H04L 9/00

(52) U.S. Cl. 380/277

(57) ABSTRACT

When a system detects that a transaction key in the SIM card (18) of a mobile station (36, 38) is non-existent or is no longer valid, the method automatically performs the following steps: generating in the application key server (42) a transaction key; encrypting the transaction key in the application server (42) using a transmission key generated when the SIM card was customized; transmitting the encrypted transition key via the SMS service centre (40) to the mobile station (36, 38); decrypting in the SIM card (18) the encrypted transaction key using the transmission key; and recording the decrypted transaction key in the SIM card storage. Furthermore, the method enables to select among several possible keys one key which corresponds both to a specific application and to a specific service provider.

The invention concerns telecommunication systems, for example of the GSM type, and, especially in such systems, a method for loading encryption keys in the mobile stations with a view to protecting the transaction made using the said mobile stations. GSM is the acronym for the English expression “Global System for Mobile communications”.

A telecommunications system of the GSM type makes it possible firstly to connect together subscribers who may belong to different telephone networks.

It also makes it possible to provide to the subscribers other services such as information, banking and stock exchange transactions, etc.

For this purpose, each mobile station is equipped with a SIM card (SIM being the acronym for the English expression “Subscriber Identity Module” or “Subscriber Identification Module” in French) which is an integrated circuit provided in particular for implementing various applications such as the services mentioned above.

The information necessary for implementing these applications are loaded in the SIM card, in general at the point of sale, in the form of computer files which are recorded in the memories of the integrated circuit.

Some of the applications such as those relating to banking and stock exchange require the transactions which are performed to be made secure. For this purpose, the transfer of information between the mobile station and the service provider is encrypted according to algorithms employing encryption keys, these keys being introduced into the SIM card at the time of the personalisation of the SIM card.

This way of proceeding does however present the following drawbacks:

the keys introduced can relate only to the applications which are loaded so that, for a new application, it is necessary to supply a new SIM card with the keys which are allocated to it,

it is not possible to change or update the keys of the application during the life of the SIM card, except by changing the card at the point of sale.

One aim of the present invention is therefore to implement a SIM card loading method which makes it possible to load encryption keys of one or more applications remotely in a secure manner, which avoids returning the card to the point of sale and withdrawing it in order to replace it with another with other keys.

This aim is achieved by effecting this loading of the keys of one or more applications by means of messages transmitted to the mobile station over a short message communication channel, such as the one known by the acronym SMS, the acronym for the English expression “Short Message Service”.

In order to provide security of the transmission, these transmitted messages are encrypted by means of a so-called “transportation” or “transmission” key which is created and recorded in the SIM card at the time of its personalisation at an operator.

Another aim of the present invention is to implement a method for the remote loading in a secure manner of encryption keys in a subscriber identification card in which the loading is preceded by a step of detecting an absence of the key or a requirement to update a key in the subscriber identification card.

The invention therefore concerns a method of loading at least one key, in particular associated with a transaction application in a subscriber identification card or module SIM for a mobile station in a telecommunication network, characterised in that it comprises the following step consisting of:

loading at least the said key during a telecommunications session of the mobile station on the telecommunication network.

The loading step is preceded by a step consisting of detecting in the subscriber identification card SIM the absence of a key or a requirement to update the said key.

The step consisting of detecting the absence of a key or the requirement to update the said key is performed by analysing at least one message of a telecommunications session. This analysis is performed either in the subscriber identification card or in a key server connected to the telecommunication network.

The analysis of at least one message of a telecommunication session is performed in a server connected to the key server.

The server connected to the key server is a server of the associated application.

The server connected to the key server is the server of the service provider of the associated application.

The message which is analysed is a cryptographic certificate.

The message which is analysed is a request from the subscriber identification card SIM.

The steps for downloading, in a secure manner, at least the said cryptographic key consist of:

encrypting the cryptographic key supplied by the key server by means of a transmission key,

transmitting the encrypted cryptographic key to the subscriber identification card SIM,

decrypting the cryptographic key in the subscriber identification card SIM by means of the transmission key, and

recording the decrypted cryptographic key in the subscriber identification card SIM.

The step consisting of downloading the said cryptographic key is performed by a short message transmission channel of the type known by the acronym “SMS” or “ESMS”.

The invention also concerns a subscriber identification card SIM for implementing the method, characterised in that it comprises a program able to detect the absence of a key or the requirement to update the key.

The subscriber identification card SIM is characterised in that it also comprises a program able to send a message requesting or updating a cryptographic key.

The application key server for implementing the method is characterised in that it comprises a program able to transmit the encrypted cryptographic key on request to a subscriber identification card SIM.

The server of the service provider for implementing the method is characterised in that it comprises a program able to analyse a message of a telecommunications session in order to determine the absence of a key or the need to update a cryptographic key.

The server of the service provider is characterised in that the program detects the absence of a key or the need for a cryptographic key from the value of a cryptographic certificate.

Moreover, it should be noted that the solution of the invention allows a dynamic application for the following reasons:

the updating or transmission of new keys is automatic;

the invention proposes a solution to an additional technical problem which stems from the fact that the same application may be shared by different service providers, each requiring different transaction keys for using the application. The invention makes it possible to select the key corresponding to the service provider to which the transaction to be performed relates: it thus makes it possible, for one and the same application, to choose from amongst several possible keys those which correspond to a certain service provider at a given moment. This solution thus makes the dynamic application of the invention implicitly possible;

the solution is based on a remote and sufficiently rapid communication technology.

Other characteristics and advantages of the present invention will emerge from a reading of the following description of a particular example embodiment, the said description being made in relation to the accompanying drawings, in which:

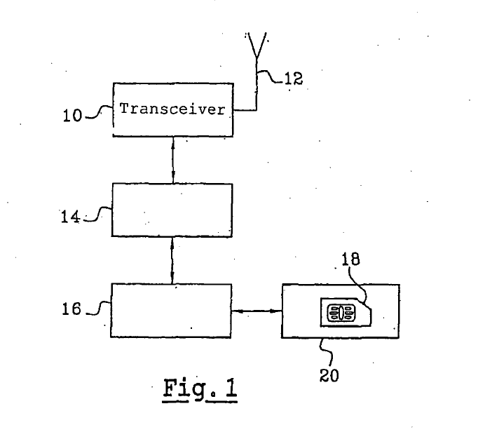

FIG. 1 is a simplified diagram of a mobile station of a telecommunication network, for example of the GSM type, and

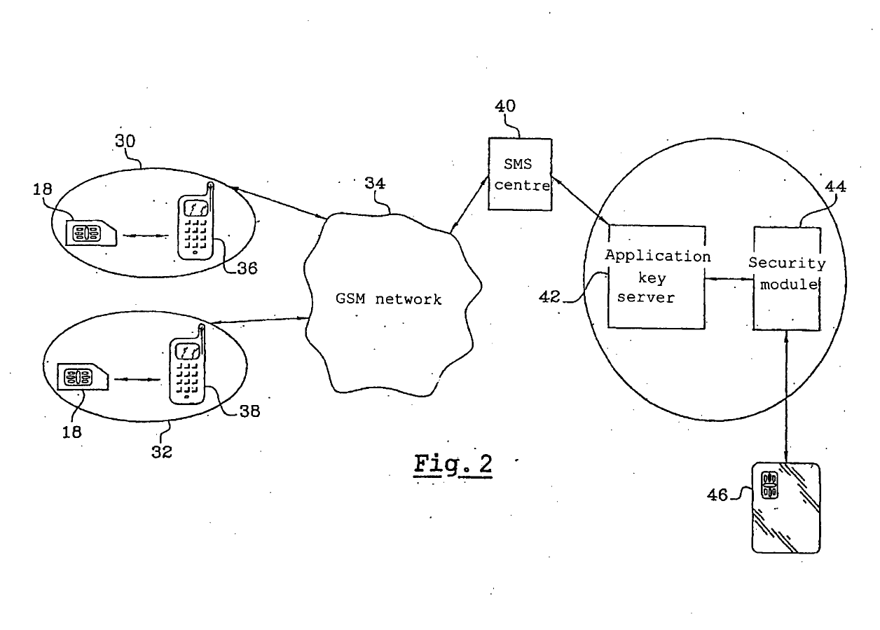

FIG. 2 is a diagram of a telecommunication network, for example of the GSM type, implementing the method of the invention.

As shown by the diagram in FIG. 1, a mobile telephone station of the GSM type comprises:

a transceiver 10 connected to an antenna 12 in order to send and receive radio signals,

a modulator/demodulator 14 for modulating and demodulating the radio signals,

a microprocessor 16 for generating the modulation signals and interpreting the demodulated signals so as to perform the telecommunication functions, and

a subscriber identification card or module SIM 18 for personalising the mobile station according to the subscriber, in particular allocating a call number to him, granting him rights of access to certain services and not others, enabling him to perform certain financial transactions such as bank transfers, stock exchange purchases/sales, etc.

The SIM card 18 is connected to the microprocessor 16 by means of a device 20 with contacts.

With regard to financial transactions, it is important that they be performed with a maximum amount of security. This security consists of an encrypting or enciphering of the messages followed by a decrypting or deciphering of these encrypted messages. These encryptings/decryptings are carried out by means of well-known algorithms using keys known solely to the operator or manager of the application and the user of the application or more exactly known to his SIM card.

In the present state of the art, the transaction key of the SIM card of the user is recorded at the time of loading of the application in the SIM card, which is not propitious for effecting a change of key which may be made necessary for reasons of security.

The invention proposes to effect this change of key or initially the loading of a key for a new application, using a short message communication channel more commonly known by the acronym SMS, standing for the English expression “Short Message Service”. This loading or change is initiated either by the user or by the service provider of the application, for example a bank for banking transactions.

The diagram in FIG. 2 shows the participants in the method of the invention. The subscribers 30 and 32 to a telecommunication network 34, for example of the GSM type, are each equipped respectively with a mobile station 36 and 38. Each mobile station 36, 38 is provided with a subscriber identification card or module SIM, such as the one referenced 18 in FIG. 1, which has been personalised in order to implement at least one application requiring security for the transactions performed by virtue of the application, for example banking or stock exchange transactions with a bank.

The GSM network 34 is under the control of a telecommunication operator (not shown) and this network is connected to an SMS centre 40. It is this SMS centre 40 which is connected to an application key server 42. The SMS centre 40 generates so-called “SMS” messages which have a given format. It can also generate “enhanced” messages known as “ESMS”, which can convey instructions of the data processing type.

The application key server 42 is connected to a security module 44 known by the acronym “HSAM” standing for the English expression “Host Secure Access Module”, this module 44 being able to be connected to an electronic chip card 46.

The key loading or change is initiated either by the SIM card of the mobile station or by the application key server after the detection of the absence of a key or a requirement to update the key by analysing a message of a telecommunication session.

Where the initiator of the key loading or change is the SIM card, the operations or steps are as follows:

(a) generating in the SIM card 18 of the mobile station 30, 32 a message requesting loading an encrypting key for the transactions according to the application,

(b) encrypting the request message in the SIM card using a transmission key recorded during the personalisation of the SIM card,

(c) transmitting the encrypted request message to the application key server 42 via the SMS server 40, (d) decrypting in the server of the application 42 the request message encrypted using the transmission key,

(e) generating in the application key server 42 a transaction key using the HSAM module 44 and possibly the electronic chip card 46,

(f) encrypting the transaction key in the application key server 42 using the transmission key,

(g) transmitting the encrypted transaction key via the SMS centre 40 to the mobile station 36 or 38,

(h) decrypting in the SIM card 18 the transaction key encrypted by means of the transmission key,

(i) recording the encrypted transaction key in the memory of the SIM card.

Where the loading or change of the transaction key is initiated by the application key server 42, the steps are as follows:

detecting in the application key server 42 the fact that in a transaction message coming from the mobile station 36, 38 the transaction key does not exist or is no longer appropriate for performing the transaction,

the other steps are identical to steps (e) to (i) of the first variant, that is to say

(e) generating in the application key server 42 a transaction key using the HSAM module 44 and possibly the electronic chip card 46,

(f) encrypting the transaction key in the application key server 42 using the transmission key,

(g) transmitting the encrypted transaction key via the SMS centre 40 to the mobile station 36 or 38,

(h) decrypting in the SIM card 18 the transaction key encrypted by means of the transmission key,

(i) recording the encrypted transaction key in the memory of the SIM card.

In the case of an application of the banking type which is used by several banks, each bank will be equipped with an application key server 42, an HSAM module 44 and an electronic chip card 46.

The banking application is loaded in the SIM card at the point of sale, the latter being connected to the application server 42.

A first transaction key can be recorded in the SIM card at the point of sale. Where the transaction key is not loaded during the loading of the application, it will be loaded before any transaction either at the initiative of the mobile station or that of the application key server 42, when the first transaction of the application is received.

The content of the transaction key depends on the application key server concerned and the bank to which the transaction relates. As a user can be connected with several banks for the same application, each bank has its own transaction key which must be recorded in the SIM card. To select the correct transaction key, the one which is allocated to the bank with which the transaction is performed, the encrypted SMS message is preceded by bytes indicating in clear, that is to say without encryption, the identity of the bank.

As indicated above, the updating or loading of a transaction key is caused either by the SIM card 18 or by the application key server 42.

In the first case, if there is no key or a wrong key in the SIM card during a transaction received and coded as an SMS short message, the application in the SIM card automatically returns to the application key server 42 an SMS short message to request implementation of the procedure of updating or loading the key. The application in the SIM card is capable of determining whether the key in its possession is correct (or exists) by analysing the message of a communication session.

In the second case, the application key server is capable of determining whether the transaction key recorded in the SIM card is correct or wrong by analysing the message of a communication session. If the key is wrong, the application key server sends an SMS short message to the card in question, the card being identified by its serial number and that of the mobile.

The method according to the invention has been described by providing an automatic detection of the absence of the key or a requirement to update a key either by the SIM card or by the application key server. However, the method can be implemented without using such an automatic detection but following an intentional initiative on the part of the user of the mobile station or the service provider.

The automatic detection of the absence of a key or the need to update the key is made by an appropriate program which, according to the circumstances, is loaded in the SIM card or in the application key server.

In the case of a loading or change following an intentional initiative, the application program will present an option for this purpose.

The analysis of the message of a telecommunications session for determining the absence of a key or the need to update a key may, instead of being performed by the application key server 42, be performed by a server connected to the application key server such as a server of the associated application or a server of the service provider of the associated application.

The message which is analysed is a cryptographic certificate or a request from the subscriber identification card SIM 18.

The subscriber identification card 18 comprises a program able to detect the absence of a key or the need to update the key. In addition, it is able to send a request message or an update message for the transaction key.

The application key server comprises a program which is able to transmit the transaction key on request to the subscriber identification card.

In a variant, the server of the service provider comprises a program able to analyse a message of a communication session in order to detect the absence of a key or the need to update a cryptographic key.

1. A method of loading at least one cryptographic key, associated with a transaction application, in a subscriber identification card for a mobile station in a telecommunication network during a secure telecommunications session of the mobile station:
automatically detecting the absence of a key or a need to update a key in the card.

2. A method according to claim 1, wherein the step of detecting the absence of a key or a need to update the key in the subscriber identification card is performed by an analysis of at least one message of a telecommunications session.

3. A method according to claim 2, wherein said analysis of at least one message of a telecommunications session is performed in the subscriber identification card.

4. A method according to claim 2, wherein said analysis of at least one message of a telecommunications session is performed in a key server.

5. A method according to claim 2, wherein said analysis of at least one message of a telecommunications session is performed in a server connected to a key server.

6. A method according to claim 2, wherein the message which is analysed is a cryptographic certificate.

7. A method according to claim 2, wherein the message which is analysed is a request of the subscriber identification card.

8. A method according to claim 1, wherein the step of loading said cryptographic key is performed by a short message transmission channel.

9. A method according to claim 8, wherein the short message comprises an identity of a service provider corresponding to the transaction application in order to select the correct key to which the transaction relates.

10. A method according to claim 9, wherein the short message comprises an unencrypted identity of the service provider and an encrypted cryptographic key.

11. A subscriber identification card that implements the method according to claim 3, comprising a program to detect the absence of a key or a need to update the key.

12. A subscriber identification card according to claim 11, further comprising a program to automatically send a message requesting or updating a cryptographic key.
